(19) United States
(12) Patent Application Publication
(10) Pub. No.: US 2026/0113134 A1
(43) Pub. Date: Apr. 23, 2026

(54) RADIO APPARATUS FOR VEHICLE AND CONTROL METHOD THEREOF

(71) Applicants: HYUNDAI MOTOR COMPANY, Seoul (KR); KIA CORPORATION, Seoul (KR)

(72) Inventors: Jae Kyu Yu, Hwaseong-si (KR); Oh Yun Kwon, Hwaseong-si (KR); Ji Hun Lim, Hwaseong-si (KR)

(73) Assignees: HYUNDAI MOTOR COMPANY, Seoul (KR); KIA CORPORATION, Seoul (KR)

(21) Appl. No.: 19/207,629

(22) Filed: May 14, 2025

(30) Foreign Application Priority Data
Oct. 17, 2024 (KR) 10-2024-0141976

(51) Int. Cl. H04H 60/88; H04B 17/309

(52) U.S. Cl. CPC H04H 60/88; H04B 17/309

(57) ABSTRACT

A radio apparatus for a vehicle and a control method thereof is provided. The radio apparatus and control method may provide an occupant of a vehicle, who cannot listen to an Internet radio, to be able to easily listen to radio broadcasts, even when a reception condition of an analog radio transmitted by a radio broadcasting station is poor. When a vehicle whose occupant can listen to the Internet radio is adjacent to a vehicle whose occupant cannot listen to the Internet radio, the Internet radio to which the vehicle whose occupant can listen, may be converted into an analog radio, and the analog radio is transmitted to the vehicle whose occupant cannot listen to the Internet radio by using one or moddre frequencies.

### CROSS-REFERENCE TO RELATED APPLICATION(S)

The present application claims priority to Korean Patent Application No. 10-2024-0141976, filed on Oct. 17, 2024, in the Korea Intellectual Property Office, the entire contents of which are incorporated herein by reference.

### TECHNICAL FIELD

The present disclosure relates to a radio apparatus for a vehicle and a control method thereof.

### BACKGROUND

This section provides background information related to the present disclosure and does not necessarily constitute prior art.

A radio and Digital Multimedia Broadcasting (DMB) are mounted on a vehicle and an occupant in the vehicle can use the radio or the DMB to listen to radio (AM/FM) broadcasts or DMB radio broadcasts.

Systems of the radio may include an analog radio such as (i) an Amplitude Modulation (AM) and Frequency Modulation (FM), (ii) a digital radio such as Digital Audio Broadcasting (DAB) and Digital Radio Mondiale (DRM), and/or (iii) an Internet radio transmitted via an Internet protocol.

An analog radio system may have a weakened reception signal, and deteriorating broadcast quality as the vehicle is located away from a transmitter of the broadcasts to which the occupant in the vehicle is listening. As an example, radio waves are less likely to reach an antenna attached to the vehicle in places such as underpasses, underground parking lots, and tunnels. Consequently, a reception rate is low.

An Internet radio system is similar to the analog radio system in that radio waves may be less likely to reach the vehicle or an in-vehicle terminal (e.g., depending on the location of the vehicle in relation to the transmitter). However, in the Internet radio system, facilities such as base stations and repeaters are more frequently (e.g., densely) installed, compared to the analog radio system. Therefore, in general, the reception rate is higher than the reception rate in the analog radio system.

Telematics technology may combine automobile and wireless communication technologies. The telematics technology is applied to various functions such as a navigation function, an information search function, an in-vehicle environment setting function, and an autonomous driving function, which may provide the ability for a driver and an occupant of the vehicle to travel comfortably.

In a connected car that can access wireless communication, for example, such as a vehicle whose occupant can listen to the Internet radio, the occupant can listen to radio broadcasts via the Internet radio regardless of a reception condition of the analog radio. Therefore, in a case of the vehicle whose occupant can listen to the Internet radio, even when the reception condition of the analog radio is poor, the occupant can listen to a desired broadcast via the Internet radio.

Therefore, it would be useful to have a technology for the occupant of the vehicle to be able to (e.g., easily) listen to a radio broadcast, even when the reception condition of the analog radio transmitted by a radio broadcasting station is weak or poor and the occupant may not be able to listen to the Internet radio.

### SUMMARY

The present disclosure provides a radio apparatus for a vehicle and a control method thereof which provide an occupant of a vehicle (e.g., who cannot listen to an Internet radio) to be able to (e.g., easily) listen to radio broadcasts (e.g., even when a reception condition of an analog radio transmitted by a radio broadcasting station is poor). The present disclosure provides a radio apparatus for a vehicle and a control method thereof. When a vehicle whose occupant can listen to the Internet radio is adjacent to a vehicle whose occupant cannot listen to the Internet radio, the Internet radio to which the vehicle whose occupant can listen is converted into an analog radio, and the analog radio is transmitted to the vehicle whose occupant cannot listen to the Internet radio by using one or more frequencies. In an example embodiment, the vehicle whose occupant cannot listen to the Internet radio receives the analog radio transmitted from the vehicle whose occupant can listen to the Internet radio by using a frequency having the most satisfactory of the one or more frequencies. Thus, in the vehicle whose occupant cannot listen to the Internet radio, the occupant may (e.g., easily) listen to radio broadcasts.

The present disclosure is not limited to those described above, and various technical objects not mentioned herein may be understood from this disclosure.

An example embodiment of the present disclosure provides a control method of a radio apparatus for a vehicle, comprising searching for frequencies at which a second analog radio is received, confirming a frequency having a most satisfactory signal quality in the frequencies, and receiving the second analog radio at the frequency having the most satisfactory signal quality, wherein the second analog radio is a signal generated by a surrounding vehicle. The signal is generated by confirming a broadcast name of an Internet radio to which an occupant of the vehicle is listening, searching for a frequency at which a first analog radio having the broadcast name is transmitted, determining whether signal quality of the first analog radio received at the frequency is satisfactory, and converting the Internet radio into the second analog radio when it is determined that the signal quality of the first analog radio is unsatisfactory.

An example embodiment of the present disclosure provides a radio apparatus for a vehicle comprising a radio control device, and an analog receiving and processing device, wherein the radio control device searches for frequencies at which a second analog radio is received, and confirms a frequency having a most satisfactory signal quality in the frequencies, wherein the analog receiving and processing device receives the frequency having the most satisfactory signal quality, wherein the second analog radio is a signal generated by a surrounding vehicle in accordance with confirming a broadcast name of an Internet radio to which an occupant of the vehicle is listening, searching for a frequency at which a first analog radio having the broadcast name is transmitted, determining whether signal quality of the first analog radio received at the frequency is satisfactory, and converting the Internet radio into the second analog radio when it is determined that the signal quality of the first analog radio is unsatisfactory.

An embodiment of the present disclosure provides a control method of a radio apparatus for a vehicle. The method includes confirming a broadcast name of an Internet radio to which an occupant of the vehicle is listening, searching for a frequency at which a first analog radio having the broadcast name is transmitted, determining whether signal quality of the first analog radio received at the frequency is satisfactory, and converting the Internet radio into the second analog radio when it is determined that the signal quality of the first analog radio is unsatisfactory.

According to an example embodiment of the present disclosure, a vehicle whose occupant can listen to an Internet radio transmits a second analog radio by using one or more frequency bands, and a vehicle whose occupant cannot listen to the Internet radio receives a second analog radio in a frequency band having a most satisfactory frequency band in the one or more frequency bands. Thus, even when the vehicle whose occupant cannot listen to the Internet radio is in an environment in which signals are unstably received, such as underpasses, and in the vehicle whose occupant cannot listen to the Internet radio, the occupant can listen to the analog radio with stable signal quality.

According to an example embodiment of the present disclosure, the vehicle whose occupant can listen to the Internet radio transmits a second analog radio at a frequency different from a frequency at which a first analog radio is transmitted. Thus, from a viewpoint of the vehicle whose occupant can listen to the Internet radio, it is possible to prevent interference between the first analog radio transmitted by a radio broadcasting station and the second analog radio transmitted by surrounding vehicles.

According to an example embodiment of the present disclosure, the vehicle whose occupant cannot listen to the Internet radio can receive the second analog radio by (e.g., periodically) monitoring electric field situations and (e.g., automatically) selecting a frequency having the most satisfactory frequency in accordance with a monitoring result. Thus, in the vehicle whose occupant cannot listen to the Internet radio, the occupant may (e.g., always) listen to the analog radio in an (e.g., optimal) reception environment.

The present disclosure is not limited to the technical effects described herein, and other technical effects may be understood from the disclosure herein.

### BRIEF DESCRIPTION OF THE DRAWINGS

FIG. 1 is a diagram of a vehicle whose occupant can listen to an Internet radio transmits an analog radio to a vehicle whose occupant cannot listen to the Internet radio according to an example embodiment of the present disclosure.

FIG. 2A is a diagram of a configuration and an operation of a radio apparatus for a vehicle which is mounted on the vehicle whose occupant can listen to the Internet radio according to the example embodiment of the present disclosure.

FIG. 2B is a diagram of a detailed configuration of the radio apparatus for the vehicle which is mounted on the vehicle whose occupant can listen to the Internet radio according to an example embodiment of the present disclosure.

FIG. 3A is a diagram for describing a configuration and an operation of the radio apparatus for the vehicle which is mounted on the vehicle whose occupant cannot listen to the Internet radio according to the example embodiment of the present disclosure.

FIG. 3B is a diagram of a detailed configuration of the radio apparatus for the vehicle which is mounted on the vehicle whose occupant cannot listen to the Internet radio according to the example embodiment of the present disclosure.

FIG. 4A is a flowchart of a method in which the vehicle, whose occupant can listen to the Internet radio, transmits the analog radio according to the example embodiment of the present disclosure.

FIG. 4B is a flowchart of a method in which the vehicle, whose occupant can listen to the Internet radio, transmits the analog radio and a shift trigger according to the example embodiment of the present disclosure.

FIG. 5A is a flowchart of a method in which the vehicle, whose occupant cannot listen to the Internet radio, receives the analog radio from the vehicle whose occupant can listen to the Internet radio according to the example embodiment of the present disclosure.

FIG. 5B is a flowchart of a method in which the vehicle, whose occupant cannot listen to the Internet radio, receives the analog radio and the shift trigger from the vehicle whose occupant can listen to the Internet radio according to the example embodiment of the present disclosure.

FIG. 6 is a block diagram of an exemplary computing device that may be used for implementing a method or an apparatus according to the present disclosure.

### DETAILED DESCRIPTION

Hereinafter, some example embodiments of the present disclosure will be described with reference to the accompanying drawings. In the following description, like reference numerals may designate like elements, although the elements are shown in different drawings. Further, in the following description of some embodiments, a detailed description of some functions and configurations incorporated therein may be omitted for clarity and for brevity.

Additionally, terms such as first, second, A, B, (a), (b), and the like, are used to differentiate one component from the other but may not imply or suggest the substances, order, or sequence of the components. Throughout this specification, when a part “includes” or “comprises” a component, the part may further include other components, generally not excluding other components, unless stated to the contrary. The terms such as ‘unit’, ‘module’, and the like refer to one or more units for processing at least one function or operation, which may be implemented by hardware, software, or a combination thereof.

The description herein, together with the accompanying drawings, may provide example embodiments of the present disclosure, and may not represent the (e.g., only) embodiments in which the present disclosure may be practiced.

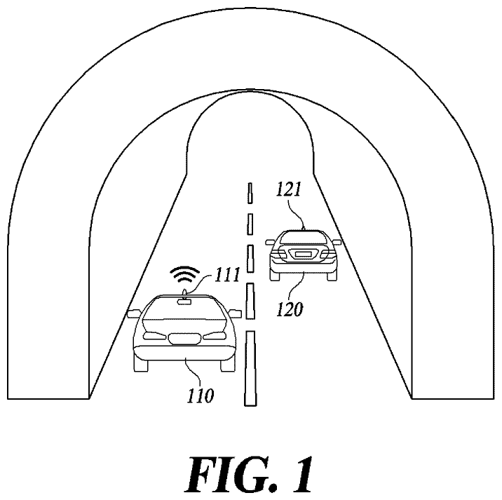

FIG. 1 is a diagram of a vehicle, whose occupant can listen to an Internet radio, transmits an analog radio to a vehicle whose occupant cannot listen to the Internet radio according to an example embodiment of the present disclosure.

Referring to FIG. 1, a vehicle whose occupant can listen to an Internet radio (110) may transmit an analog radio to a vehicle whose occupant cannot listen to the Internet radio (120), and in the vehicle whose occupant cannot listen to the Internet radio (120), the occupant may listen to the analog radio transmitted from the vehicle whose occupant can listen to the Internet radio (110). The two vehicles may be adjacent to each other. The analog radio may be a signal obtained by converting the Internet radio, to which the occupant in the vehicle whose occupant can listen to the Internet radio (110) is listening, into analog radio.

The analog radio may be transmitted and received by antennas (111 and 121) installed in respective vehicles. The antennas (111 and 121) may be rod-shaped antennas, glass antennas, and shark fin antennas. The antenna (111) may be included in a radio receiver or a radio transmitter. For example, the antenna (111) may be included in an analog radio receiving and processing device (20) or an analog radio transmitting and processing device (26). The antenna (121) may be included in a radio receiver. For example, the antenna (121) may be included in an analog radio receiving and processing device (30).

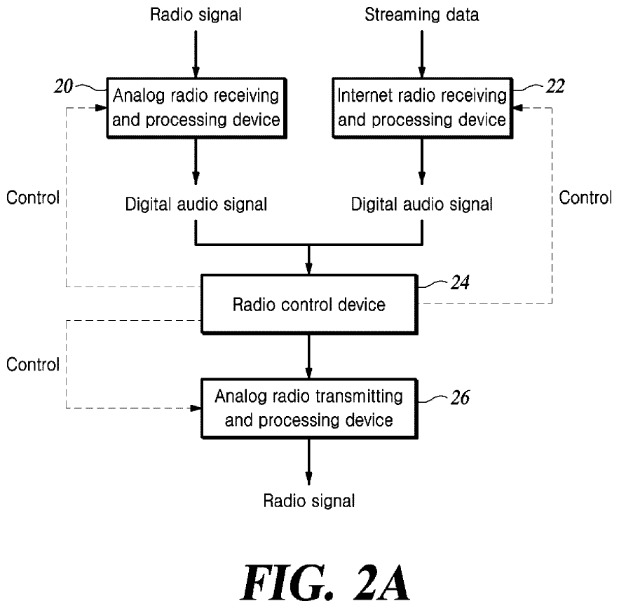

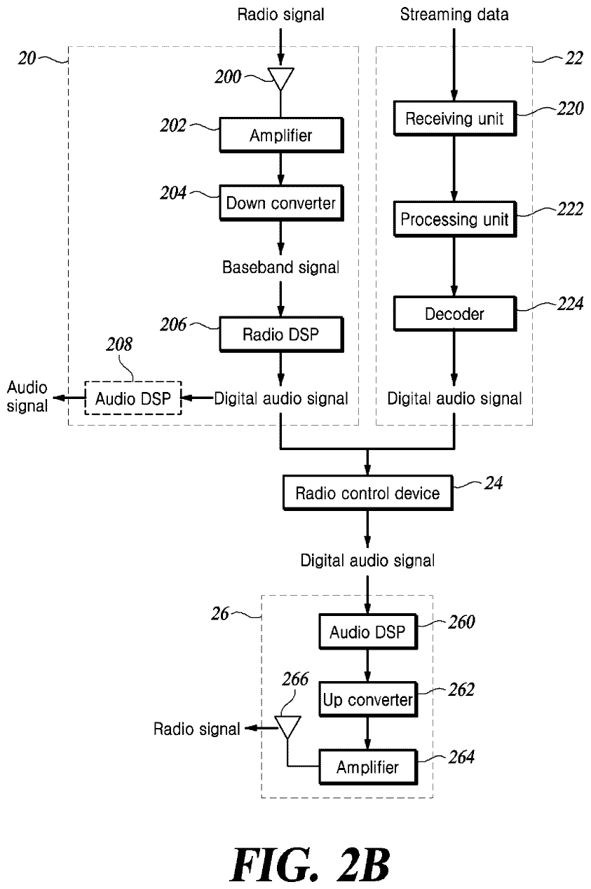

FIG. 2A is a diagram of a configuration and an operation of the radio apparatus for the vehicle which is mounted on the vehicle whose occupant can listen to the Internet radio according to the example embodiment of the present disclosure.

Referring to FIG. 2A, the radio apparatus for the vehicle which is mounted on the vehicle whose occupant can listen to the Internet radio (110) may include the analog radio receiving and processing device (20), an Internet radio receiving and processing device (22), a radio control device (24), and the analog radio transmitting and processing device (26).

The analog radio receiving and processing device (20) may receive a radio broadcast signal transmitted by a radio broadcasting station, and may convert the received radio broadcast signal into a digital audio signal. The radio broadcast signal may be provided in a form of radio waves. The radio broadcast signal may be transmitted using a transmission tower located on the ground.

The Internet radio receiving and processing device (22) may receive radio broadcasting data transmitted by the radio broadcasting station and may convert the received radio broadcasting data into a digital audio signal. The radio broadcasting data may be in the form of streaming data. The radio broadcasting data may be transmitted by using a server and the Internet.

The radio control device (24) may confirm a broadcast name of the Internet radio to which the occupant in the vehicle whose occupant can listen to the Internet radio (110) is listening. The radio control device (24) may confirm the broadcast name of the Internet radio to which the occupant in the vehicle whose occupant can listen to the Internet radio (110) is listening, based on the signal received by the Internet radio receiving and processing device (22).

The radio control device (24) may search for a frequency at which the analog radio having the same broadcast name as the broadcast name of the Internet radio to which the occupant in the vehicle whose occupant can listen to the Internet radio (110) is listening is transmitted. The radio control device (24) may search for a frequency band of the analog radio having the same broadcast name as the broadcast name of the Internet radio, based on a signal received by the analog radio receiving and processing device (20). Hereinafter, the analog radio having the same broadcast name as the broadcast name of the Internet radio may be referred to as a first analog radio.

The radio control device (24) may determine whether signal quality of the first analog radio is satisfactory at the searched frequency. Whether the signal quality is satisfactory may be determined by using an electric field strength. As a unit of the electric field strength, dBμV may be used. For example, based on the electric field strength of the first analog radio measured at a frequency at which the first analog radio is transmitted, the radio control device (24) may determine that the signal quality is unsatisfactory when the measured electric field strength is smaller than a threshold value. The threshold value may be 20 dBμV.

When it is determined that the signal quality of the first analog radio is unsatisfactory, the analog radio transmitting and processing device (26) may convert the Internet radio into a second analog radio. Hereinafter, the second analog radio may be referred to as a second analog radio to distinguish the second analog radio from the first analog radio received by the analog radio receiving and processing device (20). The analog radio transmitting and processing device (26) may receive a digital audio signal from the radio control device (24), and may convert the digital audio signal into a radio signal, based on a command of the radio control device (24). That is, the analog radio transmitting and processing device (26) may convert the Internet radio into the second analog radio, based on the digital audio signal received from the radio control device (24) and under the control of the radio control device (24). The second analog radio is obtained in such a manner that the Internet radio received by the Internet radio receiving and processing device (22) is transmitted to the analog radio transmitting and processing device (26) by the radio control device (24), and thereafter, is converted into the analog radio by the analog radio transmitting and processing device (26). The second analog radio and the first analog radio may have the same (or similar) broadcast contents, except that analog radio generating subjects are different from each other.

The analog radio transmitting and processing device (26) may transmit the second analog radio. The analog radio transmitting and processing device (26) may transmit the generated second analog radio in a form of radio waves. The transmitted second analog radio may be received by surrounding vehicles. That is, the radio apparatus for the vehicle which is mounted on the vehicle whose occupant can listen to the Internet radio (110) may transmit the second analog radio to the vehicle whose occupant cannot listen to the Internet radio (120).

The analog radio transmitting and processing device (26) may transmit the second analog radio at one or more frequencies. That is, the analog radio transmitting and processing device (26) may transmit the second analog radio by using one or more frequency bands. For example, the analog radio transmitting and processing device (26) may transmit the second analog radio at 88.2 MHz, 93.2 MHz, 98.2 MHz, 102.2 MHz, 105.2 MHz, and 108.2 MHz. As a result of the transmission, (e.g., all) contents of the radios broadcasting at 88.2 MHz, 93.2 MHz, 98.2 MHz, 102.2 MHz, 105.2 MHz, and 108.2 MHz may be the same as those of the second analog radio.

FIG. 2B is a diagram of a detailed configuration of the radio apparatus for the vehicle which is mounted on the vehicle whose occupant can listen to the Internet radio according to the embodiment of the present disclosure. FIG. 2B provides additional detail to the apparatus provided in FIG. 2A.

Referring to FIG. 2B, the radio apparatus for the vehicle which is mounted on the vehicle whose occupant can listen to the Internet radio (110) may include the analog radio receiving and processing device (20), the Internet radio receiving and processing device (22), the radio control device (24), and the analog radio transmitting and processing device (26).

The analog radio receiving and processing device (20) may include an antenna (200), an amplifier (202), a down converter (204), and a radio digital signal processor (DSP) (206). The antenna (200) may receive a radio signal. The antenna (200) may be the same device as the antenna (111). The amplifier (202) may amplify the received radio signal received by using the antenna. As a result of the amplification, a signal-to-noise ratio (SNR) of the radio signal may be improved. The amplifier (202) may be a low noise amplifier (LNA). The down converter (204) may demodulate the radio signal and may convert the demodulated radio signal into a baseband signal. The down converter (204) may include a tuner. The tuner may receive a frequency to which the occupant in the vehicle is listening. That is, the tuner may receive a signal in accordance with a frequency of a broadcast to which the occupant in the vehicle is listening. In other words, the tuner may select and receive a frequency of a specific broadcasting station from a frequency band of the broadcasting station. The tuner may include an amplifier (not illustrated), a filter (not illustrated), a mixer (not illustrated), and an oscillator (not illustrated). The amplifier (not illustrated) included in the tuner may be different than (e.g., distinguished from) the amplifier (202). For example, the amplifier (not illustrated) included in the tuner may be an intermediate frequency amplifier. The tuner may demodulate the radio signal, and may convert the demodulated radio signal into the baseband signal. That is, the tuner may demodulate an electromagnetic wave signal, and may convert the demodulated electromagnetic wave signal into the analog signal. The radio DSP (206) may convert the baseband signal into the digital audio signal. In order to improve signal quality, the radio DSP (206) may perform processing such as equalizing, noise reduction, and filtering.

Alternatively, the analog radio receiving and processing device (20) may include an audio DSP (208). The audio DSP (208) may convert a digital audio signal into an audio signal. The audio signal may be an analog signal. The audio signal may be transmitted to the occupant of the vehicle by using an output device (not illustrated) a speaker, for example.

The Internet radio receiving and processing device (22) may include a receiving unit (220), a processing device (222), and a decoder (224). The receiving unit (220) may receive streaming data. The receiving unit (220) may be implemented by using a network interface card (NIC, not illustrated) and a router. The receiving unit (220) may be connected to a network to receive data. The network may be the Internet. The data may be radio broadcasting data, such as streaming data. The streaming data may be received in a form of packets. The processing device (222) may process the streaming data. The processing device may be use a memory (not illustrated) and a processor (not illustrated). The processing device (222) may reassemble the streaming data in the form of packets, and may process the streaming data into an audio stream. The decoder (224) may convert the audio stream into a digital audio signal. The decoder (224) may be implemented by using a digital signal processor (DSP, not illustrated). A process of converting the audio stream into the digital audio signal may include a process of decoding compressed data.

The radio control device (24) may be implemented by using a computing device (60). One or more processes performed by the radio control device (24) may be performed by a processor (620) included in the computing device (60). That is, the processor (620) may confirm the broadcast name of the Internet radio to which the occupant is listening, may search for the frequency at which the first analog radio having the same broadcast name as the Internet radio to which the occupant is listening is transmitted, and may determine whether the signal quality of the first analog radio received at the searched frequency is satisfactory.

The analog radio transmitting and processing device (26) may include an audio DSP (260), an up converter (262), an amplifier (264), and an antenna (266). The antenna (266) may be the same device as the antenna (111). When some of the processes performed by the analog radio receiving and processing device (20) are reversely performed, the process becomes a process performed by the analog radio transmitting and processing device (26). Thus, the vehicle whose occupant can listen to the Internet radio (110) may use the receiving antenna as the transmitting antenna (e.g., when necessary). That is, the antenna (200) and the antenna (266) may be the same antenna (111). The audio DSP (260) may convert a digital audio signal into a baseband signal. The audio DSP (260) may include a digital-to-analog converter (DAC). The up converter (262) may modulate the baseband signal, and may convert the baseband signal into the radio signal. The up converter (262) may include an amplifier (not illustrated), a filter (not illustrated), a mixer (not illustrated), and an oscillator (not illustrated). The amplifier (not illustrated) included in the up converter (262) may be distinguished from the amplifier (264). The amplifier (264) may amplify the radio signal converted by using the up converter. The amplifier (264) may be a power amplifier (PA). The antenna (266) may transmit the amplified radio signal.

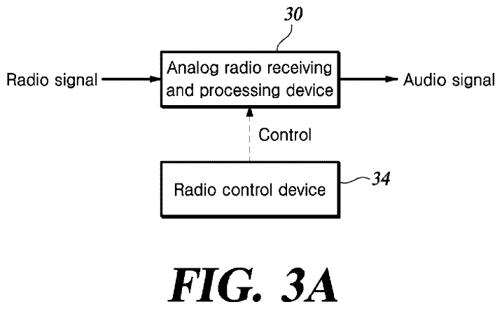

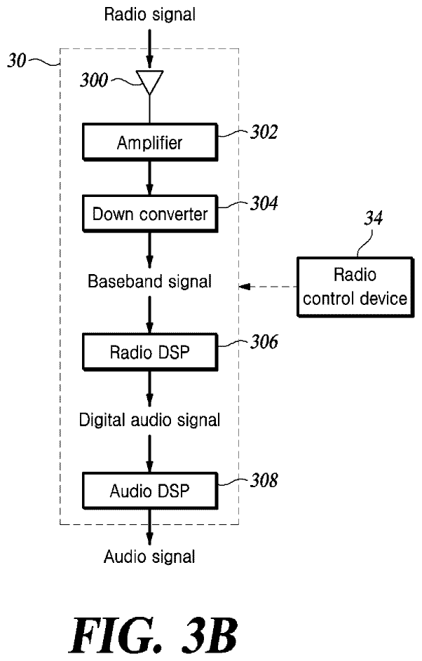

FIG. 3A is a diagram of a configuration and an operation of the radio apparatus for the vehicle which is mounted on the vehicle whose occupant cannot listen to the Internet radio according to an example embodiment of the present disclosure.

Referring to FIG. 3A, the radio apparatus for the vehicle which is mounted on the vehicle whose occupant cannot listen to the Internet radio (120) may include an analog radio receiving and processing device (30) and a radio control device (34).

In general, the analog radio receiving and processing device (30) may receive radio broadcasting data transmitted by a radio broadcasting station, and may convert the received radio broadcast signal into the audio signal. The radio broadcasting data may be in a form of radio waves. The radio broadcast signal may be transmitted by using a transmission tower located on the ground.

In the present disclosure, when the vehicle whose occupant cannot listen to the Internet radio (120) enters an underground passage, an underground parking lot, a tunnel, or the like, signal quality of radio broadcasting data transmitted from the radio broadcasting station, that is, the first analog radio, may deteriorate. In this case, the radio apparatus for the vehicle which is mounted on the vehicle whose occupant cannot listen to the Internet radio (120) may receive the radio broadcasting data transmitted by the vehicle whose occupant can listen to the Internet radio (110), that is, the second analog radio, and may convert the received radio broadcasting signal into the audio signal. That is, the radio apparatus for the vehicle which is mounted on the vehicle whose occupant cannot listen to the Internet radio (120) may receive the second analog radio having satisfactory signal quality, instead of the first analog radio having unsatisfactory signal quality.

The radio control device (34) may search for the frequency at which the second analog radio is received. The radio control device (34) may search for the frequency band at which the second analog radio is received, based on the signal received by the analog radio receiving and processing device (30).

There may be one or more frequencies at which the second analog radio is received. Since the analog radio transmitting and processing device (26) of the vehicle whose occupant can listen to the Internet radio (110) transmits the second analog radio by using one or more frequency bands, the radio control device (34) of the vehicle whose occupant cannot listen to the Internet radio (120) may search for one or more frequencies at which the second analog radio is received. For example, the radio control device (34) may search for 88.2 MHz, 93.2 MHz, 98.2 MHz, 102.2 MHz, 105.2 MHz, and 108.2 MHz which are frequencies at which the second analog radio is received, based on the signal received by the analog radio receiving and processing device (30).

The radio control device (34) may confirm the frequency having the most satisfactory in the searched frequencies. The radio control device (34) may compare the signal quality of each frequency, based on a strength, a noise level, and an interference degree of the signal received at each of the searched frequencies. Table 1 shows the strength, the noise level, and the interference degree of the signal received at each of the searched frequencies as an example.

TABLE 1

| Frequency (MHz) | 88.2 | 93.2 | 98.2 | 102.2 | 105.2 | 108.2 |
|---|---|---|---|---|---|---|
| Strength (dBuV) | 50 | 70 | 70 | 30 | 20 | 10 |
| Noise Level (%) | 20 | 20 | 10 | 40 | 45 | 50 |
| Interference Degree (%) | 20 | 30 | 10 | 40 | 45 | 50 |

Referring to Table 1, the strength, the noise level, and the interference level of the signal received at each of the searched frequencies, that is, 88.2 MHz, 93.2 MHz, 98.2 MHz, 102.2 MHz, 105.2 MHz, and 108.2 MHz, are shown. The signal strength may be a value representing strength of an electromagnetic field in a space where the signal is propagated. That is, the signal strength may be represented by using electric field strength. The unit of the signal strength may be dBuV. The noise level may be a value representing a ratio of noise components in the signal. Noise may be a noise component in an ultrasonic band. The unit of the noise level may be %. The interference degree may be a value representing a degree to which the received signal is distorted or superimposed due to a multipath phenomenon. The interference degree may be a ratio of an interference phenomenon that occurs when the signal reaches a receiver through multiple paths. The unit of the interference degree may be %.

The radio control device (34) may determine that the frequency having the highest signal strength is the frequency having the most satisfactory signal quality. When there are frequencies having the same signal strength, the radio control device (34) may determine that the frequency having a lower noise level is the frequency having the most satisfactory. That is, the radio control device (34) may primarily select the frequency by considering the signal strength as the first priority, and thereafter, may secondarily select the frequency by considering the noise level as the second priority. For example, the radio control device (34) may primarily select highest 93.2 MHz and 98.2 MHz which have the highest signal strength of 70 dBuV from 88.2 MHz, 93.2 MHz, 98.2 MHz, 102.2 MHz, 105.2 MHz, and 108.2 MHz. Continuing with the example, the radio control device (34) may secondarily select 98.2 MHz which has a noise level as low as 10%, and finally, the radio control device (34) may confirm 98.2 MHz as the frequency having the most satisfactory signal quality.

In the present disclosure, the process of confirming the frequency having the most satisfactory signal quality by considering the signal strength as the first priority and the noise level as the second priority is provided. However, the scope of the present disclosure is not limited thereto. According to an example embodiment, the radio control device (34) may determine the signal quality of each frequency, based on a result determined by assigning priorities different from those in the present disclosure to the signal strength, the noise level, and the interference degree. According to an example embodiment, the radio control device (34) may also determine the signal quality of each frequency, based on a result value calculated by assigning proper a weighted value to the signal strength, the noise level, and the interference degree.

The analog radio receiving and processing device (30) may receive the second analog radio at the frequency having the most satisfactory signal quality. The frequency having the most satisfactory signal quality may be a frequency confirmed by the radio control device (34). The analog radio receiving and processing device (30) may receive the second analog radio at the frequency confirmed by the radio control device (34) to have the most satisfactory signal quality, based on a command of the radio control device (34). That is, the analog radio receiving and processing device (30) may receive the second analog radio at the frequency having the most satisfactory signal quality, based on the control of the radio control device (34). For example, the analog radio receiving and processing device (30) may receive the second analog radio at 98.2 MHz which is determined to have the most satisfactory signal quality, in 88.2 MHz, 93.2 MHz, 98.2 MHz, 102.2 MHz, 105.2 MHz, and 108.2 MHz. In this way, in the present disclosure, the vehicle whose occupant can listen to the Internet radio transmits the second analog radio by using one or more frequency bands, and the vehicle whose occupant cannot listen to the Internet radio may receive the second analog radio in the frequency band having the most satisfactory signal quality in one or more frequency bands. In this manner, the vehicle whose occupant cannot listen to the Internet radio may listen to the analog radio with stable signal quality even when the vehicle is in an environment where signal reception is unstable, such as underpasses.

FIG. 3B is a diagram of a configuration of the radio apparatus for the vehicle which is mounted on the vehicle whose occupant cannot listen to the Internet radio according to an example embodiment of the present disclosure.

Referring to FIG. 3B, the radio apparatus for the vehicle which is mounted on the vehicle whose occupant cannot listen to the Internet radio (120) may include the analog radio receiving and processing device (30) and the radio control device (34).

The analog radio receiving and processing device (30) may include an antenna (300), an amplifier (302), a down converter (304), a radio DSP (306), and an audio DSP (308). The analog radio receiving and processing device (30) may be (e.g., substantially) the same device as the analog radio receiving and processing device (20). Therefore, each component included in the analog radio receiving and processing device (30) may be omitted below, as the description in FIG. 2B is hereinabove. The antenna (300) may be (e.g., substantially) the same device as the antenna (121).

The radio control device (34) may be implemented with the computing device (60). One or more processes performed by the radio control device (34) may be performed by the processor (620) included in the computing device (60). That is, the processor (620) may search for the frequency at which the second analog radio is received, and may determine the frequency having the most satisfactory signal quality in the searched frequencies.

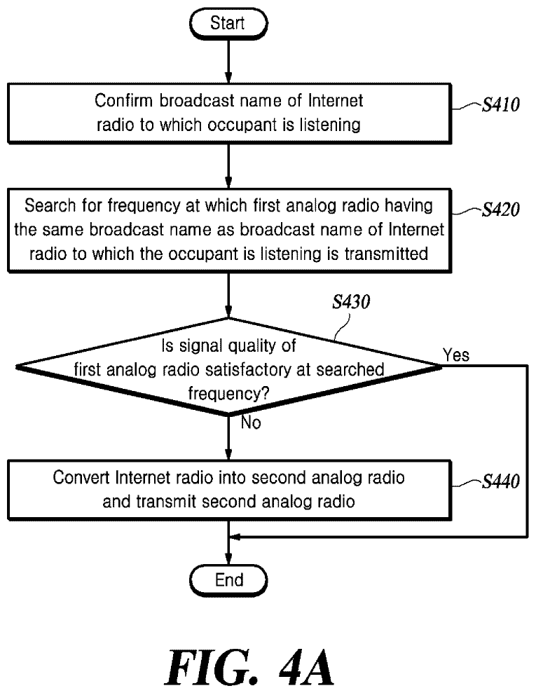

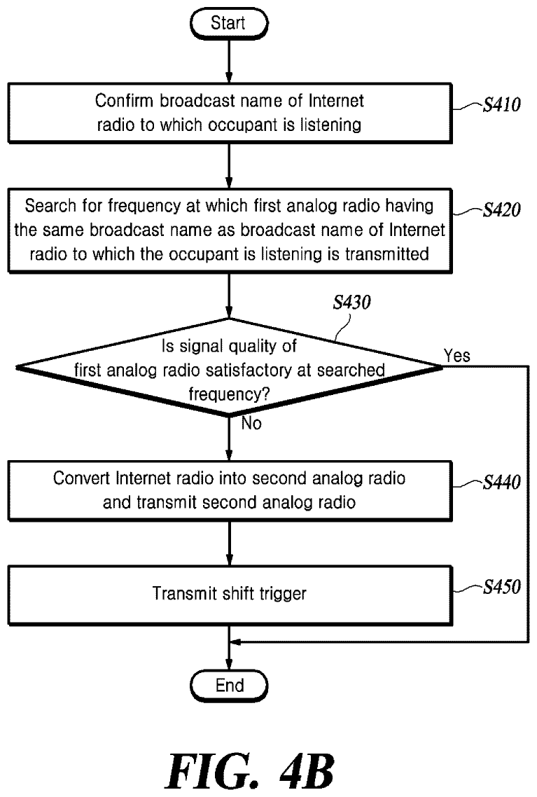

FIG. 4A is a flowchart of a method in which the vehicle, whose occupant can listen to the Internet radio, transmits the analog radio according to an example embodiment of the present disclosure.

Referring to FIG. 4A, the radio control device (24) may confirm the broadcast name of the Internet radio to which the occupant is listening (S410).

The radio control device (24) may search for the frequency at which the analog radio having the same broadcast name as the broadcast name of the Internet radio to which the occupant is listening is transmitted (S420).

The radio control device (24) may determine whether the signal quality of the first analog radio at the searched frequency is satisfactory (S430).

When it is determined that the signal quality of the first analog radio is unsatisfactory, the analog radio transmitting and processing device (26) may convert the Internet radio into the second analog radio, and may transmit the second analog radio (S440). That is, when the quality of the analog radio signal transmitted from the radio broadcasting station deteriorates as the vehicle enters the underpass, the underground parking lot, the tunnel, or the like, the vehicle whose occupant can listen to the Internet radio (110) may convert the Internet radio into the analog radio, and may transmit the analog radio to the vehicle whose occupant cannot listen to the Internet radio (120) so that the occupant in the vehicle whose occupant cannot listen to the Internet radio (120) can easily listen to the radio. The vehicle whose occupant can listen to the Internet radio (110) and the vehicle whose occupant cannot listen to the Internet radio (120) may be adjacent to each other, and may be in the same environment (underpasses, underground parking lots, or tunnels).

FIG. 4B is a flowchart of a method in which the vehicle, whose occupant can listen to the Internet radio, transmits the analog radio and a shift trigger according to an example embodiment of the present disclosure. Compared to FIG. 4A, in FIG. 4B, a process in S450 is added.

Referring to FIG. 4B, the analog radio transmitting and processing device (26) may transmit the shift trigger (S450). The shift trigger is a signal generated by the vehicle whose occupant can listen to the Internet radio (110) so that the vehicle whose occupant cannot listen to the Internet radio (120) can (e.g., easily) distinguish the first analog radio from the second analog radio. At least one oscillator may be additionally used to generate the shift trigger.

The analog radio transmitting and processing device (26) may transmit the shift trigger through the frequency which is the same as the frequency of the first analog radio, and may transmit the second analog radio through the frequency which is different from the frequency of the first analog radio. For example, when the first analog radio is transmitted at 89.1 MHz, the analog radio transmitting and processing device (26) may transmit the shift trigger at 89.1 MHz, and may transmit the second analog radio at 89.2 MHz. As another example, when the first analog radio is transmitted at 89.1 MHz, the analog radio transmitting and processing device (26) may transmit the shift trigger at 89.1 MHz, and may transmit the second analog radio at 88.2 MHz, 93.2 MHz, 98.2 MHz, 102.2 MHz, 105.2 MHz, or 108.2 MHz. In this way, in the present disclosure, the vehicle whose occupant can listen to the Internet radio may transmit the second analog radio at the frequency different from the frequency at which the first analog radio is transmitted. In this manner, it may be possible to prevent or minimize interference between the first analog radio and the second analog radio from the viewpoint of the vehicle whose occupant can listen to the Internet radio.

In FIG. 4B, a process in S450 is performed after a process in S440, but the scope of the present disclosure is not limited thereto. That is, according to an example embodiment, the order of the process in S450 and the process in S440 may be changed, and the processes may be (e.g., substantially) simultaneously performed.

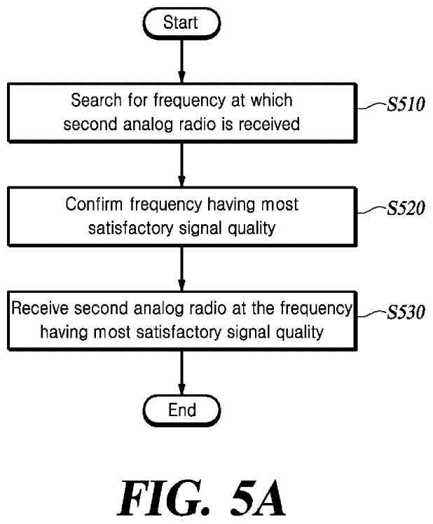

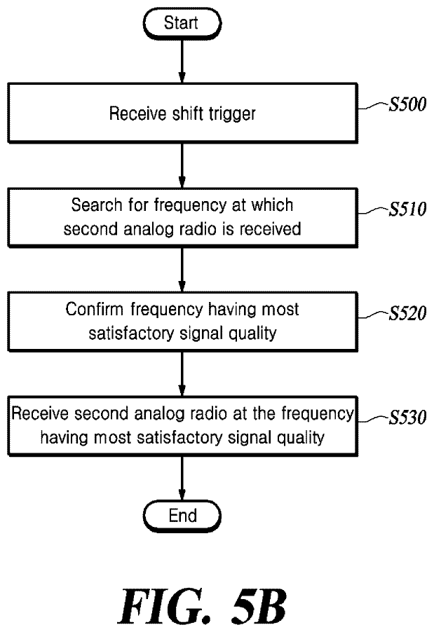

FIG. 5A is a flowchart of a method in which the vehicle, whose occupant cannot listen to the Internet radio, receives the analog radio from the vehicle, whose occupant can listen to the Internet radio, according to an example embodiment of the present disclosure.

Referring to FIG. 5A, the radio control device (34) may search for the frequency at which the second analog radio is received (S510).

The radio control device (34) may confirm the frequency having the most satisfactory signal quality in the searched frequencies (S520).

The analog radio receiving and processing device (30) may receive the second analog radio at the frequency having the most satisfactory signal quality (S530). The second analog radio may be the analog radio transmitted by the vehicle whose occupant can listen to the Internet radio (110). That is, the second analog radio may be the analog radio generated and transmitted, based on the processes including the processes in S410 to S440. In other words, when the quality of the analog radio signal transmitted from the radio broadcasting station deteriorates, such as when the vehicle enters an underpass, an underground parking lot, a tunnel, or the like, the vehicle whose occupant cannot listen to the Internet radio (120) may receive the analog radio transmitted to surrounding vehicles in such a manner that the vehicle whose occupant can listen to the Internet radio (110) converts the Internet radio into the analog radio. The surrounding vehicles may be the vehicle whose occupant cannot listen to the Internet radio (120). The vehicle whose occupant can listen to the Internet radio (110) and the vehicle whose occupant cannot listen to the Internet radio (120) may be adjacent to each other, and may be in the same environment (e.g., underpasses, underground parking lots, or tunnels).

The analog radio receiving and processing device (30) may receive the second analog radio at the frequency determined to have the most satisfactory signal quality by the radio control device (34) in one or more frequencies at which the second analog radio is received. The second analog radio may be the analog radio transmitted by the vehicle whose occupant can listen to the Internet radio (110) at one or more frequencies. That is, the second analog radio may be the analog radio transmitted from the vehicle whose occupant can listen to the Internet radio (110) in one or more frequency bands, based on the process in S440. In other words, when the quality of the analog radio signal transmitted from the radio broadcasting station deteriorates as the vehicle enters the underpass, the underground parking lot, the tunnel, or the like, the vehicle whose occupant can listen to the Internet radio (110) may convert the Internet radio into the analog radio, and thereafter, may transmit the analog radio to the vehicle whose occupant cannot listen to the Internet radio (120) by using one or more frequency bands. In this way, in the present disclosure, the vehicle whose occupant can listen to the Internet radio may transmit the second analog radio by using one or more frequency bands, and the vehicle whose occupant cannot listen to the Internet radio may receive the second analog radio in the frequency band having the most satisfactory signal quality in the one or more frequency bands. In this manner, the vehicle whose occupant cannot listen to the Internet radio may listen to the analog radio with stable signal quality even when the vehicle is in an environment where signal reception is unstable, such as the underpasses.

Alternatively, a process in S520 may be repeated at a regular time interval. The radio control device (34) may confirm the frequency having the most satisfactory signal quality at a regular time interval. Accordingly, the analog radio receiving and processing device (30) may receive the second analog radio at the most satisfactory frequency determined by the radio control device (34) based on latest signal quality criteria. In this way, in the present disclosure, the vehicle whose occupant cannot listen to the Internet radio may periodically monitor electric field conditions, may (e.g., automatically) select the frequency having the most satisfactory signal quality, and may receive the second analog radio, based on the result. In this manner, the vehicle whose occupant cannot listen to the Internet radio may (e.g., always) listen to the analog radio in an (e.g., optimal) receiving environment.

FIG. 5B is a flowchart of a method in which the vehicle whose occupant cannot listen to the Internet radio receives the analog radio and the shift trigger from the vehicle whose occupant can listen to the Internet radio according to an embodiment of the present disclosure. Compared to FIG. 5A, in FIG. 5B, a process in S500 is added.

Referring to FIG. 5B, the analog radio receiving and processing device (30) may receive the shift trigger (S500). The shift trigger is provided with the discussion of FIG. 4B. The shift trigger may be a signal generated by the vehicle whose occupant can listen to the Internet radio (110).

The analog radio receiving and processing device (30) may receive the shift trigger through the frequency which is (e.g., substantially) the same as the frequency of the first analog radio, and may receive the second analog radio through the frequency which is different from the frequency of the first analog radio. For example, when the first analog radio is transmitted at 89.1 MHz, the analog radio receiving and processing device (30) may receive the shift trigger at 89.1 MHz (S500), and may receive the second analog radio at 88.2 MHz, 93.2 MHz, 98.2 MHz, 102.2 MHz, 105.2 MHz, and 108.2 MHz. The process of receiving the second analog radio may be performed, based on the process (S510) in which the radio control device (34) searches for the frequency at which the second analog radio is received. The radio control device (34) may search for the frequency at which the second analog radio is received, based on the shift trigger received by the analog radio receiving and processing device (30).

Thereafter, the radio control device (34) may confirm that the frequency having the most satisfactory signal quality in 88.2 MHz, 93.2 MHz, 98.2 MHz, 102.2 MHz, 105.2 MHz, and 108.2 MHz is 98.2 MHz (S520). Based on this confirmation, the analog radio receiving and processing device (30) may receive the second analog radio at 98.2 MHz (S530).

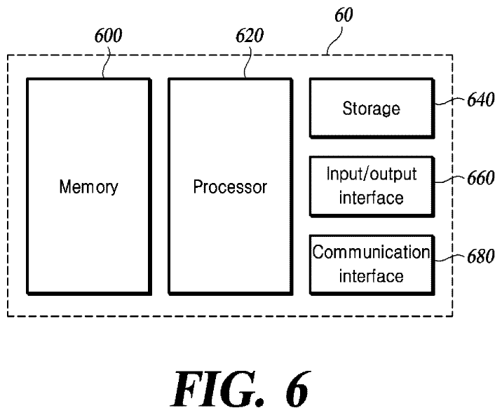

FIG. 6 is a block diagram of an exemplary computing device that may be used for implementing a method or an apparatus according to the present disclosure.

The computing device (60) may include a memory (600), a processor (620), a storage (640), an input/output interface (660), and/or a communication interface (680). The computing device (60) may be a stationary computing device, such as a desktop computer or a server, or a mobile computing device, such as a laptop computer or a smart phone. The computing device (60) may include a specialized hardware accelerator capable of processing operations of an artificial intelligence model in an efficient manner. For example, the computing device (60) may include a graphic processing unit (GPU), a tensor processing unit (TPU), or a neural processing unit (NPU).

The memory (600) may store a program that provides the processor (620) to perform methods or operations according to various embodiments of the present disclosure. For example, a program may include a plurality of instructions executable by the processor (620), and the methods or operations described above may be performed by executing the plurality of instructions by the processor (620). The memory (600) may include a single memory or a plurality of memories. In this case, information (e.g., required) to perform the methods or operation according to various embodiments of the present disclosure may be stored in a single memory or distributed across a plurality of memories. When the memory (600) is composed of a plurality of memories, the plurality of memories may be (e.g., physically) separated. The memory (600) may include at least one of volatile memory and non-volatile memory. Volatile memory includes Static Random Access Memory (SRAM) or Dynamic Random Access Memory (DRAM), while non-volatile memory includes flash memory.

The processor (620) may include at least one core capable of executing at least one instruction. The processor (620) may execute instructions stored in the memory (600). The processor (620) may include a single processor or a plurality of processors.

The storage (640) may maintain stored data even if power supplied to the computing device (60) is removed. For example, the storage (640) may include non-volatile memory or may include a storage medium such as a magnetic tape, an optical disk, or a magnetic disk. A program stored in the storage (640) may be loaded into the memory (600) before being executed by the processor (620). The storage (640) may store files written in a program language, and a program created from the files by a compiler may be loaded into the memory (600). The storage (640) may store data to be processed by the processor (620) and/or data processed by the processor (620).

The input/output interface (660) may provide an interface with an input device such as a keyboard or a mouse and/or an output device such as a display device or a printer. The user may trigger execution of a program by the processor (620) through the input device and/or check the processing results of the processor (620) through the output device.

The communication interface (680) may provide access to an external network. The computing device (60) may communicate with other devices through the communication interface (680).

Each element of the apparatus or method in accordance with the present disclosure may be provided in the form of hardware or software, or a combination of hardware and software. The functions of the (e.g., respective) elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a specialized (e.g., special purpose) processor or a general purpose processor, coupled to receive and transmit data and instructions from and to a storage system, at least one input device, and at least one output device. Computer programs (also known as programs, software, software applications, or code) may include instructions for a programmable processor and may be stored in a “computer-readable recording medium.”

The computer-readable recording medium may include (e.g., all) types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is description of example embodiments of the present disclosure and the flowcharts/timing charts may be performed or implemented in any suitable order. In other words, the present disclosure may include various modifications and changes. For example, the sequence illustrated in the flowcharts/timing charts can be changed and one or more operations of the operations can be performed in parallel or in a different order. Thus, flowcharts/timing charts are not limited to the temporal order.

Although exemplary embodiments of the present disclosure have been described for illustrative purposes, various modifications, additions, and substitutions are possible, without departing from the present disclosure. Therefore, the embodiments provided herein are examples and the scope the example embodiments in the present disclosure is not limited by the figures. Accordingly, the claimed disclosure is not limited by the above example embodiments nor limited by the claims and equivalents provided herein.

What is claimed is:

1. A control method of a radio apparatus for a vehicle, comprising:
searching for frequencies at which a second analog radio is received;
confirming a frequency having a most satisfactory signal quality in the frequencies; and
receiving the second analog radio at the frequency having the most satisfactory signal quality,
wherein the second analog radio is a signal generated by a surrounding vehicle by:
confirming a broadcast name of an Internet radio to which an occupant of the vehicle is listening;
searching for a frequency at which a first analog radio having the broadcast name is transmitted;
determining whether a signal quality of the first analog radio received at the frequency is satisfactory; and
converting the Internet radio into the second analog radio when it is determined that the signal quality of the first analog radio is unsatisfactory.

2. The control method of the radio apparatus for a vehicle of claim 1,
wherein a number of the frequencies at which the second analog radio is received is one or more,
wherein confirming the frequency having the most satisfactory signal quality in the frequencies includes comparing the signal quality, based on at least one of a strength, a noise level, and an interference degree of a signal measured at the frequencies.

3. The control method of the radio apparatus for a vehicle of claim 2,
wherein comparing the signal quality, based on at least one of the strength, the noise level, and the interference degree of the signal measured at the frequency includes:
determining a frequency having a highest strength of the signal in the frequencies as the frequency having the most satisfactory signal quality; and
determining a frequency having a lower noise level as the frequency having the most satisfactory signal quality, when frequencies having the same strength of the signal are included in the frequencies.

4. The control method of the radio apparatus for a vehicle of claim 1, further comprising:
receiving a shift trigger before searching for the frequency at which the second analog radio is received,
wherein the shift trigger is a signal generated by the surrounding vehicle to distinguish the second analog radio from the first analog radio.

5. A radio apparatus for a vehicle comprising:
a radio control device; and
an analog receiving and processing device,
wherein the radio control device searches for frequencies at which a second analog radio is received, and confirms a frequency having a most satisfactory signal quality of the frequencies,
wherein the analog receiving and processing device receives the frequency having the most satisfactory signal quality,
wherein the second analog radio is a signal generated by a surrounding vehicle by:
confirming a broadcast name of an Internet radio to which an occupant of the vehicle is listening;
searching for a frequency at which a first analog radio having the broadcast name is transmitted;
determining whether signal quality of the first analog radio received at the frequency is satisfactory; and
converting the Internet radio into the second analog radio when it is determined that the signal quality of the first analog radio is unsatisfactory.

6. The radio apparatus for a vehicle of claim 5,
wherein a number of the frequencies at which the second analog radio is received is one or more,
wherein the radio control device compares the signal quality, based on at least one of a strength, a noise level, and an interference degree of a signal measured at the frequencies.

7. The radio apparatus for a vehicle of claim 6, wherein the radio control device determines a frequency having a highest strength of the signal in the frequencies as the frequency having the most satisfactory signal quality, and
determines a frequency having a lower noise level as the frequency having the most satisfactory signal quality, when frequencies having the same strength of the signal are included in the frequencies.

8. The radio apparatus for a vehicle of claim 5,
wherein the radio control device further receives a shift trigger before searching for a frequency at which the second analog radio is received,
wherein the shift trigger is a signal generated by the surrounding vehicle to distinguish the second analog radio from the first analog radio.

9. A control method of a radio apparatus for a vehicle, comprising:
confirming a broadcast name of an Internet radio to which an occupant of the vehicle is listening;
searching for a frequency at which a first analog radio having the broadcast name is transmitted;
determining whether a signal quality of the first analog radio received at the frequency is satisfactory; and
converting the Internet radio into a second analog radio when it is determined that the signal quality of the first analog radio is unsatisfactory.

10. The control method of the radio apparatus for a vehicle of claim 9, wherein the second analog radio is transmitted at one or more frequencies.

11. The control method of the radio apparatus for a vehicle of claim 9, further comprising:
receiving a shift trigger, wherein the shift trigger is a signal generated by a surrounding vehicle to distinguish the second analog radio from the first analog radio.
